(19) United States
(12) Patent Application Publication
(10) Pub. No.: US 2018/0070542 A1
(43) Pub. Date: Mar. 15, 2018

(54) SCREWLESS DRIP WATERING SYSTEM

(71) Applicant: WATERPULSE, INC., Longmont, CO (US)

(72) Inventors: Yugen Patrick Lockhart, Palo Alto, CA (US); Ronald L. Johnson, San Jose, CA (US)

(21) Appl. No.: 15/260,572

(22) Filed: Sep. 9, 2016

(51) Int. Cl. A01G 25/02; A01G 9/02; A01G 25/16; B05B 1/20

(52) U.S. Cl. CPC A01G 25/023; A01G 25/026; A01G 2025/006; A01G 25/165; B05B 1/20; A01G 9/024

(57) ABSTRACT

A drip irrigation system for irrigating one or more zones and/or areas. The irrigation system comprises a waterline and one or more drip watering devices. The one or more drip watering devices are able to fit around and attach to a wire, a frame, a post a hook, a vertical pole and/or a horizontal pole quickly and easily without the use of screws or other tools. In some embodiments, the one or more watering devices comprise a u-shaped recess that is configured to accept one or more hanging pots and/or baskets. Coupling the one or more hanging pots and/or baskets with the one or more watering devices opens the valve to drip irrigate the hanging pots and/or baskets through one or more drip lines.

### FIELD OF THE INVENTION

The present invention relates to systems for delivering water to plants and soil. More particularly, the present invention relates to drip watering systems for delivering water to a specific area.

### BACKGROUND OF THE INVENTION

Irrigation systems are used in order to artificially apply water to an area where it is needed but not necessarily present. Automated and semi-automated irrigation systems enable areas of agriculture, landscaping and planting to be watered with little effort after the system is configured to deliver a necessary amount of water at a specified time. One key to an effective system is to get as much water and nutrients to the area as possible without over watering. Drip irrigation, rather than casting a wide spray or steady stream of water over a large area, deposits a low-pressure water stream to watering areas. Still though, drip irrigation systems may be inefficient if the systems drip water unnecessarily in areas where no water is needed.

### SUMMARY OF THE INVENTION

An automatic drip watering system comprises a waterline and one or more drip watering devices. The one or more drip watering devices each comprise a valve, which is configured to open and drip irrigate an area when weight is applied to the drip watering device. The one or more drip watering devices are able to fit around and attach to a wire, a frame, a post a hook, a vertical pole and/or a horizontal pole quickly and easily without the use of screws or other tools. In some embodiments, the one or more watering devices comprise a u-shaped recess that is configured to accept one or more hanging pots and/or baskets. Coupling the one or more hanging pots and/or baskets with the one or more watering devices opens the valve to drip irrigate the hanging pots and/or baskets through one or more drip lines.

In one aspect, a drip watering system comprises one or more waterlines, and a watering device coupled to the one or more waterlines, the watering device comprising a first section, a second section, wherein the first section screwlessly connects to the second section to secure the watering device to an additional object, and one or more valves configured to open and deliver water to an area when weight is added to the watering device. In some embodiments, the first section snap fits to the second section to secure the watering device to an additional object. In some embodiments, the watering area comprises one or more hanging pots and/or hanging baskets. In some embodiments, the watering device comprises a u-shaped recess that is configured to accept one or more hanging pots and/or baskets. In further embodiments, drip watering system comprises one or more additional watering devices. In some embodiments, the watering device and the one or more additional watering devices are coupled to the same waterline. Alternatively, in some embodiments, the watering device and the one or more additional watering devices are coupled to a different waterline. In some embodiments, the watering device and the one or more additional watering devices independently water a different area. In some embodiments, the one or more waterlines comprise a ¼-inch drip line. In further embodiments, the watering system is grouped into multiple zones. In further embodiments, the watering system comprises a timer for starting and stopping the watering system at a predetermined time.

In another aspect, a drip watering device comprises a first section, a second section, wherein the first section screwlessly connects to the second section to secure the watering device to an additional object, and one or more valves configured to open and deliver water to an area when weight is added to the watering device. In some embodiments, the first section snap fits to the second section to secure the watering device to an additional object. In some embodiments, the watering area comprises one or more hanging pots and/or hanging baskets. In some embodiments, the watering device comprises a u-shaped recess that is configured to accept one or more hanging pots and/or baskets. In some embodiments, the watering device is coupled to a waterline. The additional object is able to comprise one of a frame, a post, a hook, a vertical pole, and a horizontal pole.

In a further aspect, a method of drip watering comprises fitting one or more drip watering devices to a water line, wherein a first section of a drip watering device screwlessly connects to a second section of the drip watering device to secure the watering device to an additional object, and fit the one or more drip watering devices with a waterline, coupling one or more plants are coupled to the one or more drip watering devices and supplying water to the one or more plants. In some embodiments, the one or more plants comprise one or more hanging pots. In some of these embodiments, the one or more hanging pots are configured to hang on a u-shaped recess of the one or more watering devices. In some embodiments, the one or more watering devices are grouped into multiple zones. In further embodiments, the method comprises operating a timer for starting and stopping watering at a predetermined time.

### BRIEF DESCRIPTION OF THE DRAWINGS

FIGS. 1A and 1B illustrate an exploded view of a drip watering device in accordance with some embodiments.

FIGS. 2A and 2B illustrate a drip watering system in accordance with some embodiments.

FIG. 3 illustrates a method of drip watering in accordance with some embodiments.

FIG. 4 illustrates a drip watering system in accordance with some embodiments.

### DETAILED DESCRIPTION OF THE INVENTION

In the following description, numerous details are set forth for purpose of explanation. However, one of ordinary skill in the art will realize that the invention may be practiced without the use of these specific details or with equivalent alternatives. Thus, the presently claimed invention is not intended to be limited to the embodiments shown but is to be accorded the widest scope consistent with the principles and features described herein. Throughout the description similar components are similarly marked in order to aid comprehension.

Embodiments are directed to a drip irrigation system for irrigating one or more zones and/or areas. The irrigation system comprises a waterline and one or more drip watering devices. The one or more drip watering devices are able to fit around and attach to an additional object quickly and easily without the use of screws or other tools. In some embodiments, the one or more watering devices comprise a u-shaped recess that is configured to accept one or more hanging pots and/or baskets. Coupling the one or more hanging pots and/or baskets with the one or more watering devices opens the valve to drip irrigate the hanging pots and/or baskets through one or more drip lines.

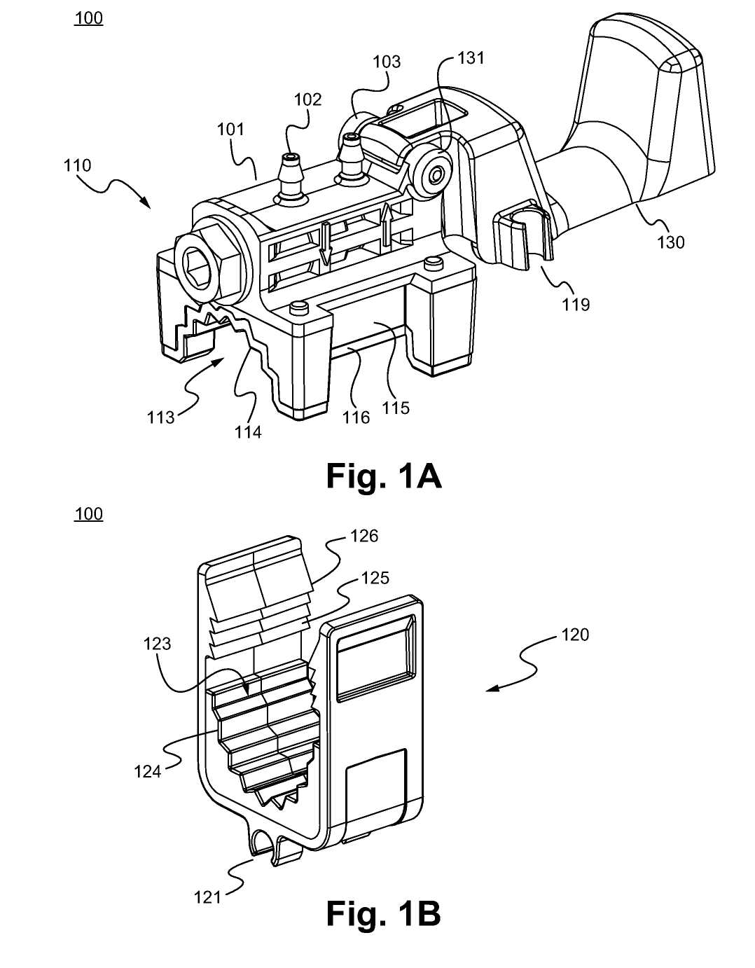

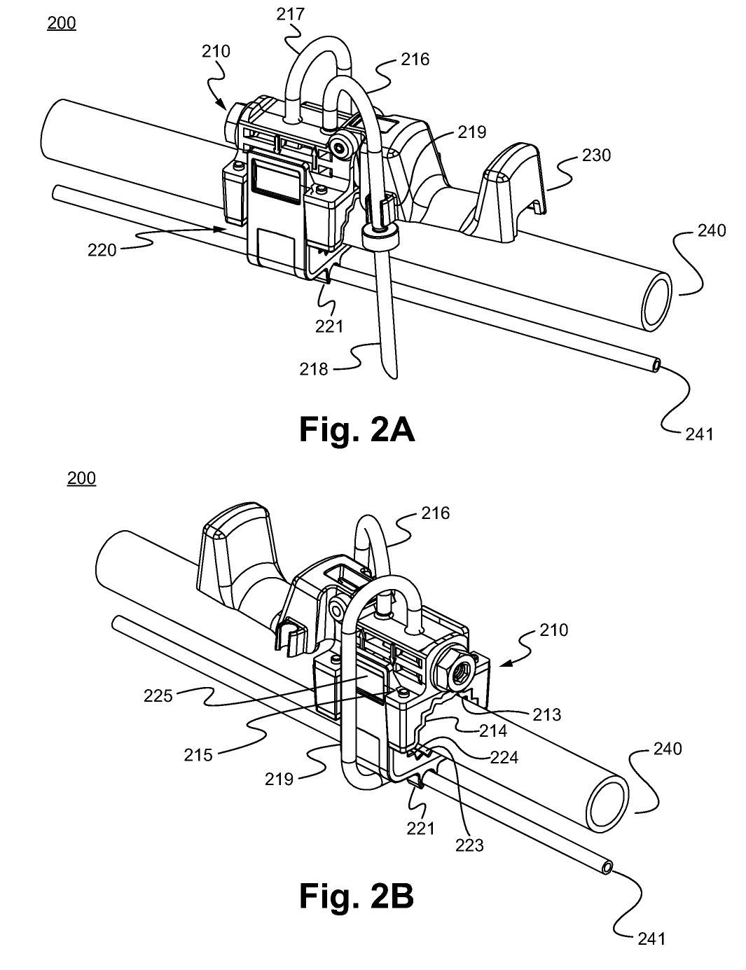

Referring to FIGS. 1A and 1B, an exploded view of a drip watering device 100 is depicted therein. The drip watering device 100 comprises an upper body 110 and a lower body 120. FIG. 1A depicts an upper body 110 and a u-shaped recess 130 coupled to the upper body 110. The u-shaped recess 130 is configured to receive one of a hanging pot and/or a hanging basket. In some embodiments, the u-shaped recess 130 comprises a drip line holder 119 and is coupled to the upper body 110 at a hinge 131. In some embodiments, the drip line holder 119 is coupled directly to the body 110. In some embodiments, when weight is added to the u-shaped recess 130, one or more valves of the watering device 100 are opened and water is able to be delivered through a drip line 218 (FIG. 2) to a desired area. Particularly, in some embodiments, the one or more valves remain closed until sufficient weight is added to the watering device.

As further shown within FIG. 1A, the upper body 110 comprises a valve body 101 and an upper jaw 113. The upper jaw 113 is configured to enable the upper body 110 to couple with an additional object. Particularly, the upper jaw 113 is configured to fit around the additional object, such as described below. In some embodiments, the upper jaw 113 comprises one or more teeth 114 for gripping the additional object. The valve body 101 comprises one or more ports 102 and 103. In some embodiments, the one or more ports 102 and 103 comprise an inflow port and an outflow port. In some embodiments, the lower jaw 120 comprises a water line holder 121 for holding a waterline.

As shown within FIG. 1B, the lower body 120 comprises a lower jaw 123 that is configured to enable the lower body 120 to couple with an additional object. Particularly, the lower jaw 123 is configured to fit around the additional object, such as described below. In some embodiments, the lower jaw 123 comprises one or more teeth 124 for gripping the additional object. Both the upper jaw 113 and the lower jaw 123 fit around an additional object. The tongue portion 125 of the lower body 120 is fit within the groove 115 of the upper body 110. As described above, in some embodiments, the tongue portion 125 comprises one or more teeth 126 that fit around a lip of the groove 115 to securely couple the upper body 110 with the lower body 120 of the drip watering device 100. In some embodiments, the tongue 125 comprises a plurality of teeth 126 such that the upper body 110 and the lower body 120 are able to couple together around a variety of sizes of objects. In some embodiments, the upper body 110 and the lower body 120 are able to snap-fit around the additional object. The upper body 110 and the lower body 120 are able to comprise a variety of different profiles to fit around differently sized objects.

FIGS. 2A and 2B illustrate a drip watering system in accordance with some embodiments. As shown within FIGS. 2A and 2B, the system 200 comprises one or more waterlines 241, and a drip watering device 200. The one or more waterlines 241 are able to comprise any appropriately sized waterline capable of delivering a sufficient amount of water to the drip watering device 200. The watering device 200 is similar to the watering device 100, such as described above, and comprises one or more valves, which are configured to open and deliver water to an area when weight is added to the watering device 200. The one or more valves remain closed until sufficient weight is added to the watering device 200. As described above, in some embodiments, coupling the one or more hanging pots and/or baskets with the one or more watering devices opens the valve to drip irrigate the hanging pots and/or baskets through one or more drip lines. The system 200 is able to be used with any appropriately sized hanging plant or hanging arrangement that needs to be watered.

The drip watering device 200 comprises one or more drip waterlines 217 and 216. The inflow drip waterline 217 connects to the port 102 and the outflow drip waterline 216 connects to the port 103, such as described above. As shown within FIG. 2B, the waterline 217 also connects to the waterline 241 to supply water to the outflow drip waterline 216 and the drip line 218 that is held by the water line holder 121. As described above, the u-shaped recess 230 is configured to receive one of a hanging pot and/or a hanging basket. The u-shaped recess 230 comprises a drip line holder 219 and is coupled to the upper body 210 at a hinge 231. In some embodiments, when weight is added to the u-shaped recess 230, one or more valves of the watering device 200 are opened and water is able to be delivered through a drip line 218 to a desired area.

As further shown within FIG. 2B, the upper body 210 and the lower body 220 have been coupled together such that the upper jaw 213 and the lower jaw 223 have been fit around an additional object 240. As described above, the upper jaw 213 is able to securely grip the additional object 240 with the one or more teeth 214 and the lower jaw 223 is able to securely grip the additional object 240 with the one or more teeth 224. With the upper jaw 213 and the lower jaw 223 fit around an additional object 240. The tongue portion 225 of the lower body 220 is fit within the groove 215 of the upper body 210. As described above, in some embodiments, the tongue portion 225 comprises one or more teeth that fit around a lip of the groove 215 to securely couple the upper body 210 with the lower body 220 of the drip watering device 200. In some embodiments, the tongue 225 comprises a plurality of teeth such that the upper body 210 and the lower body 220 are able to couple together around a variety of sizes of objects. In some embodiments, the upper body 210 and the lower body 210 are able to snap-fit around the additional object 240. Particularly, the drip watering device 200 is able to couple to any appropriate object that allows the drip watering device to remain a sufficient height off the ground so that the one or more valves are able to open when weight is added to the device 200. For example, in some embodiments, the drip watering device 200 is coupled to one of a wire, a frame, a post, a hook, a vertical pole, and a horizontal pole.

In some embodiments, the valve body is configured to connect to a ¼-inch drip line. However, the valve is able to connect to any appropriately sized drip line.

In some embodiments, the additional object the drip watering device 200 couples to is a water supply line, hose or tube. In such an embodiment, the water input port 214 is internal and couples directly with the water supply line.

In some embodiments, a plurality of drip watering devices 200 are coupled together in order to drip irrigate multiple hanging pots, baskets, and/or watering areas. In some embodiments, the plurality of watering devices 200 are coupled to the same waterline.

Alternatively, or in conjunction, a plurality of different watering devices 200 couple to a plurality of different waterlines. In some embodiments, the plurality of drip watering devices 200 are configured to independently water an area. For example, in some embodiments, only watering devices 200 that comprise a hanging plant and/or basket provide drip irrigation. Particularly, the one or more watering devices 200 are able to be grouped into multiple zones. In some embodiments, a timer is used for starting and stopping the drip watering at predetermined times. Additionally, in some embodiments, a plurality of watering devices 200 are ran according to one or more of an on/off switch, a programmable irrigation timer, one or more environmental sensors, a controller, and an irrigation system operation circuit as described in the co-owned patent application Ser. No. 13/914,466, and entitled INJECTOR STYLE IRRIGATION SYSTEM, which is hereby incorporated by reference.

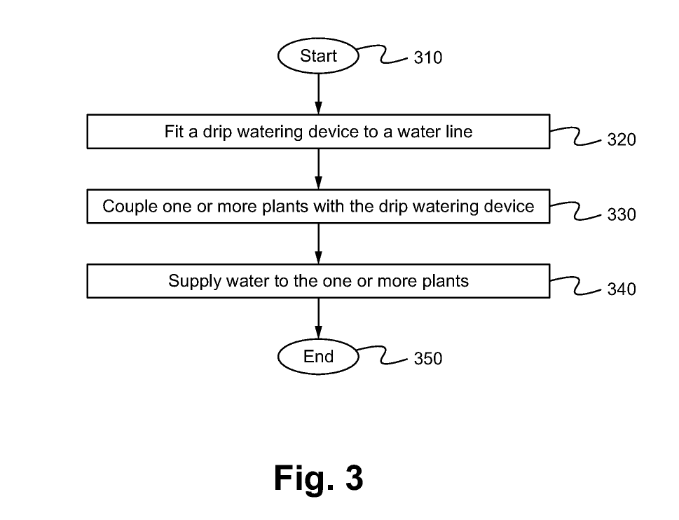

FIG. 3 illustrates a method of drip irrigation in accordance with some embodiments. The method begins in the step 310. In the step 320, one or more drip watering devices are fit to a watering line. As described above, in some embodiments, fitting the one or more drip watering devices are fit to one of a wire, a frame, a post, a hook, a vertical pole, and a horizontal pole to couple with the watering line. In some embodiments, the one or more drip watering devices are snap fit. Particularly, the drip watering device is able to couple to any appropriate object that allows the drip watering device to remain a sufficient height off the ground so that the one or more valves are able to open. Additionally, as described above, the one or more waterlines are able to comprise any appropriately sized waterline capable of delivering a sufficient amount of water to a drip watering device. In the step, 330 one or more plants are coupled to the one or more drip watering devices. In some embodiments, the one or more watering devices comprise a u-shaped recess that is configured to accept one or more hanging pots and/or baskets. Then, in the step 340, water is supplied to the one or more plants. As described above, in some embodiments, coupling one or more hanging pots and/or baskets with the one or more watering devices opens the valve to drip irrigate the hanging pots and/or baskets through one or more drip lines. The method ends in the step 350.

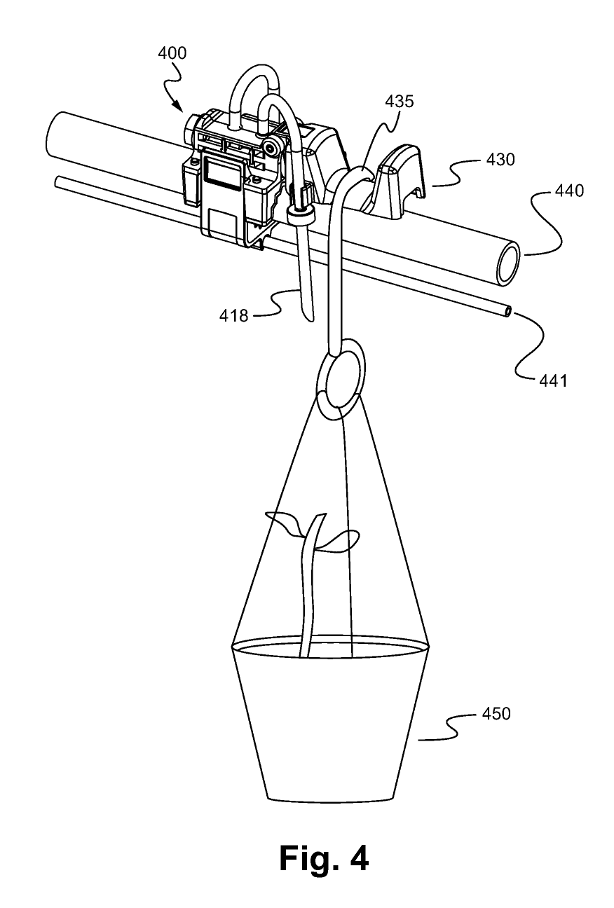

FIG. 4 illustrates a drip watering system in accordance to some embodiments such as described above. The drip watering system comprises one or more waterlines 441, and a drip watering device 400, such as described above. The one or more waterlines 441 are able to comprise any appropriately sized waterline capable of delivering a sufficient amount of water to the drip watering device. The watering device comprises a body comprising one or more valves, which are configured to open and deliver water to an area when weight is added to the system 400, such as described above. The one or more valves remain closed until sufficient weight is added to the watering system 400. As shown within FIG. 4, the watering device is coupled to a horizontal pole. However, as described above, the watering device is able to fit around and attach to a wire, a frame, a post a hook, a vertical pole and/or a horizontal pole quickly and easily without the use of screws or other tools.

As shown in FIG. 4, a hanging pot and/or basket 450 with a hanger 435 has been hung on a u-shaped recess 430 of the watering system 400. The hanging pot/and or basket 450 adds sufficient weight to the u-shaped recess 430 in order to pull it to a down position and open the one or more valves and provide drip watering to the hanging pot and/or basket 450. Although a u-shaped recess and a hanger 435 are shown in FIG. 4, a hanging pot and/or basket is able to couple with the drip watering system 400 by any appropriately desired method. As further shown in FIG. 4, the drip watering system 400 comprises one or more drip waterlines 418 for directing the water flow. The drip watering system is able to be used with any appropriately sized hanging plant or hanging arrangement that needs to be watered.

The drip irrigation system, device and method is configured to provide drip irrigation to one or more hanging pots and/or baskets in order to save time, effort and maintenance while watering a group of plants or area. Particularly, only to those devices which have pots and/or baskets to be watered provide drip irrigation. If there is no weight on the device, indicating an absence of a hanging pot and/or basket, then the watering valve remains closed and no water is provided. Particularly, water is saved by only watering those areas where it is needed. Additionally, because the drip irrigation is automatic it only needs to be set up once in order to correctly water. Further, because the device is able to be secured by coupling an upper section with a lower section, the drip irrigation device is able to be quickly and securely coupled to an additional article without the use of tools and in a time efficient manner. Accordingly, the irrigation system as described herein has many advantages.

The invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications area able to be made in the embodiment chosen for illustration without departing from the spirit and scope of the invention. Specifically, it will be apparent that the design of the irrigation system is able to be implemented in many different styles and configurations. Further, it will be apparent to one of ordinary skill in the art that the precise structure of the device is able to be substantially varied to accommodate various styles of water sources and watering areas. Consequently, the claims should be broadly construed, consistent with the spirit and scope of the invention, and should not be limited to their exact, literal meaning.

We claim:

1. A drip watering system comprising:
a. one or more waterlines; and
b. a watering device coupled to the one or more waterlines, the watering device comprising:
i. a first section;
ii. a second section, wherein the first section screwlessly connects to the second section to secure the watering device to an additional object, and
iii. one or more valves configured to open and deliver water to an area when weight is added to the watering device.

2. The drip watering system of claim 1, wherein the first section snap fits to the second section to secure the watering device to an additional object.

3. The drip watering system of claim 1, wherein the watering area comprises one or more hanging pots and/or hanging baskets.

4. The drip watering system of claim 3, wherein the watering device comprises a u-shaped recess that is configured to accept one or more hanging pots and/or baskets.

5. The drip watering system of claim 1, comprising one or more additional watering devices.

6. The drip watering system of claim 5, wherein the watering device and the one or more additional watering devices are coupled to the same waterline.

7. The drip watering system of claim 5, wherein the watering device and the one or more additional watering devices are coupled to a different waterline.

8. The drip watering system of claim 5, wherein the watering device and the one or more additional watering devices independently water a different area.

9. The drip watering system of claim 1, wherein the one or more waterlines comprise a ¼-inch drip line.

10. The drip watering system of claim 1, wherein the watering system is grouped into multiple zones.

11. The drip watering system of claim 1 further comprising a timer for starting and stopping the watering system at a predetermined time.

12. A drip watering device comprising:
a. a first section;
b. a second section, wherein the first section screwlessly connects to the second section to secure the watering device to an additional object, and
c. one or more valves configured to open and deliver water to an area when weight is added to the watering device.

13. The drip watering device of claim 12, wherein the first section snap fits to the second section to secure the watering device to an additional object.

14. The drip watering device of claim 12, wherein the watering area comprises one or more hanging pots and/or hanging baskets.

15. The drip watering device of claim 12, wherein the watering device comprises a u-shaped recess that is configured to accept one or more hanging pots and/or baskets.

16. The drip watering device of claim 12, wherein the watering device is coupled to a waterline.

17. The drip watering device of claim 15, wherein the additional object comprises one of a frame, a post, a hook, a vertical pole, and a horizontal pole.

18. A method of drip watering comprising:
a. fitting one or more drip watering devices to a water line, wherein a first section of a drip watering device screwlessly connects to a second section of the drip watering device to secure the watering device to an additional object, and fit the one or more drip watering devices with a waterline;
b. coupling one or more plants are coupled to the one or more drip watering devices; and
c. supplying water to the one or more plants.

19. The method of claim 18, wherein the one or more plants comprise one or more hanging pots.

20. The method of claim 18, wherein the one or more hanging pots are configured to hang on a u-shaped recess of the one or more watering devices.

21. The method of claim 17, wherein the one or more watering devices are grouped into multiple zones.

22. The method of claim 17, further comprising operating a timer for starting and stopping watering at a predetermined time.
